(19) United States
(12) Patent Application Publication
(10) Pub. No.: US 2024/0208811 A1
(43) Pub. Date: Jun. 27, 2024

(54) PROCESS FOR SYNTHESIS OF SYNGAS COMPONENTS

(71) Applicants: Kansas State University Research Foundation, Manhattan, KS (US); Hydrograph Clean Power Inc., Vancouver (CA)

(72) Inventors: Christopher M. Sorensen, Manhattan, KS (US); Stefan H. Bossmann, Fairway, KS (US); Justin Wright, Manhattan, KS (US); Shusil Sigdel, Manhattan, KS (US); Jose Covarrubias, Manhattan, KS (US); Arjun Nepal, Manhattan, KS (US); Harold Charles Davidson, Vancouver (CA)

(21) Appl. No.: 18/550,752

(22) PCT Filed: Mar. 16, 2022
(86) PCT No.: PCT/US2022/020544

§ 371 Date: Sep. 15, 2023

Related U.S. Application Data
(60) Provisional application No. 63/161,625, filed on Mar. 16, 2021.

(51) Int. Cl. C01B 3/36

(52) U.S. Cl. CPC C01B 3/36; C01B 2203/0255; C01B 2203/0405; C01B 2203/1217; C01B 2203/1235; C01B 2203/1276; C01B 2203/1614; C01B 2203/169

(57) ABSTRACT

Apparatus and processes for high-yield production of syngas components via combustion of a carbon-containing material and an oxygen-containing material are provided. Syngas components are generated in an exothermic, combustion reaction with only minor quantities of carbon dioxide, water, and elemental carbon produced.

### RELATED APPLICATION

The present application claims the benefit of U.S. Provisional Patent Application No. 63/161,625, filed Mar. 16, 2021, and is incorporated by reference herein in its entirety.

### BACKGROUND OF THE INVENTION

### Field of the Invention

The present invention is generally directed toward processes for high-yield production of syngas components, namely hydrogen and carbon monoxide, via combustion of a carbon-containing material and an oxygen-containing material.

### Description of the Prior Art

Synthesis gas, or syngas, is a fuel gas mixture that comprises primarily hydrogen and carbon monoxide. Syngas has many important industrial uses. It is a valuable intermediate resource for the production of hydrogen, ammonia, methanol, and synthetic hydrocarbons via the Fischer-Tropsch process. Moreover, hydrogen is viewed as an important “green” energy source as it can be combusted with oxygen to produce only water as a byproduct.

Syngas is often produced by energy intensive (endothermic) reactions, such as steam reforming of methane and coal gasification. Alternative technologies have also been devised for syngas production including biomass catalytic partial oxidation, and decomposition of methane followed by addition of carbon dioxide at temperatures exceeding 1000° C., and electrolysis of water. However, due to the externally supplied energy demands of these processes, the economics associated with these processes are highly sensitive to energy costs.

Therefore, there is a need in the art for a process that is capable of producing syngas in a less energy-demanding manner, and even more preferably according to an exothermic process whose energy demands are small or essentially nil. Natural gas is often viewed as a low-value fuel and is commonly flared off in many petroleum processing facilities. Moreover, as the production of electric vehicles increases, corn farmers may experience lower demand for ethanol-containing fuels. It would be beneficial to make use of both of these materials to synthesize syngas components.

Sorensen et al., U.S. Pat. No. 9,440,857, have demonstrated that high yields of carbon in the form of graphene can be produced by detonating a hydrocarbon/oxidizer mixture under extreme temperatures of at least 3000 K. However, such a process appears inapposite to synthesis of gaseous products as Sorensen's process is focused on producing solid carbon particulates.

### SUMMARY OF THE INVENTION

According to one embodiment of the present invention there is provided a method of synthesizing syngas components. The method comprises providing within a combustion vessel a mixture comprising a combustible carbon-containing material and an oxidizing agent (i.e., an oxygen-containing material) for the carbon-containing material. The mixture is combusted within the vessel at a temperature of less than 3000 K. Carbon monoxide hydrogen, and optionally elemental carbon, can be generated as combustion products.

According to another embodiment of the present invention there is provided a method of synthesizing syngas components comprising premixing a carbon-containing material with an oxygen-containing material to form a combustible mixture. The mixing can be performed using digital controls to mix the materials in optimal ratios for the desired reaction products. The carbon-containing material comprises at least one of methane, ethane, propane, butane, pentane, methanol, ethanol, propanol, and butanol. The combustible mixture is introduced into a combustion chamber and combusted therein at a temperature of 2000 K or less. Carbon monoxide, hydrogen, and optionally elemental carbon, can be generated as combustion products.

According to yet another embodiment of the present invention there is provided a method of synthesizing syngas components. The method comprises introducing into a premixing vessel at least one source of a carbon-containing material and at least one source of an oxygen-containing material to form a combustible mixture, wherein the ratio of the oxygen-containing material to the carbon-containing material within the premixing vessel is controlled, preferably digitally controlled, to provide an oxygen to carbon ratio that is less than the stoichiometric oxygen to carbon ratio for the oxygen-containing material and the carbon-containing material. At least a portion of the combustible mixture is fed to a combustion vessel and combusted therein at a temperature of 2000 K or less to generate carbon monoxide, hydrogen, and optionally elemental carbon, as combustion products.

According to still a further embodiment of the present invention apparatus for synthesizing syngas components is provided. The apparatus comprises at least one source of a carbon-containing material and at least one source of an oxygen-containing material. A mixing vessel is provided that is operably coupled with the at least one source of a carbon-containing material and the at least one source of an oxygen-containing material. The mixing vessel is configured to receive and mix the carbon-containing material and the oxygen-containing material from each respective source and to form a combustible mixture. A combustion vessel is operably coupled with the mixing vessel and configured to receive the combustible mixture from the mixing vessel and combust the combustible mixture within the combustion vessel to generate carbon monoxide, hydrogen, and optionally elemental carbon, as combustion products. The combustion vessel is configured to combust the combustible mixture at a temperature of less than 3000 K. A digital control system is also provided and configured to control the ratio of oxygen-containing material to carbon-containing material within the mixing vessel to provide an oxygen to carbon ratio that is less than the stoichiometric oxygen to carbon ratio for the oxygen-containing material and the carbon-containing material.

### BRIEF DESCRIPTION OF THE DRAWINGS

FIG. 1 is a schematic diagram of a process for synthesizing syngas components according to one embodiment of the present invention; and

FIG. 2 is a chart of the molar ratio of H₂ and CO products to CH₄ (methane) precursor versus the ratio of the chamber initial and final pressures (before and after combustion).

### DETAILED DESCRIPTION OF THE PREFERRED EMBODIMENT

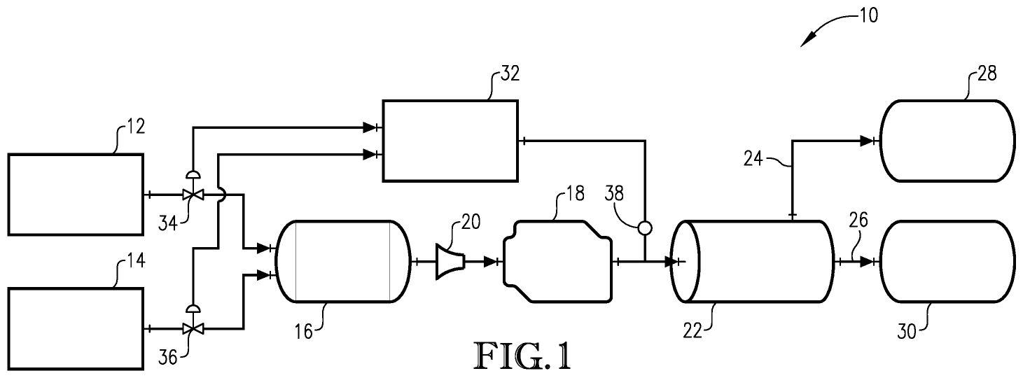

FIG. 1 depicts a system 10 for synthesizing syngas components according to one embodiment of the present invention. A fuel source 12 comprising a carbon-containing material is provided, as is a source of an oxygen-containing material 14.

In one or more embodiments, the carbon-containing material comprises one or more carbon-containing compounds. In one or more embodiments, the carbon-containing compounds can be in the form of a solid, liquid, or a gas; however, liquid and gaseous carbon-containing compounds are preferred. If provided in a solid form, the carbon-containing compounds are preferably provided in the form of very small particulates, which may be dispersed or suspended in a gas or liquid carrier material.

In preferred embodiments, the carbon-containing compounds comprise volatile organic compounds, which can be in the form of vapors at standard atmospheric pressure and room temperature (approximately 25° C.), or in the form of liquids or solids at standard atmospheric pressure and temperature but are capable of being vaporized upon being heated. In certain embodiments, it is preferable for volatile organic compounds to be used that exist as vapors at temperatures of up to 150° C., up to 120° C., or up to 100° C. at pressures of at least 1, 2, 3, 4, or 5 atmospheres, and/or not more than 15, 14, 13, 12, 11, or 10 atmospheres.

Exemplary carbon-containing compounds useful as a fuel source include hydrocarbon compounds, especially saturated or unsaturated C1-C12 hydrocarbon compounds, and alcohols, especially C1-C12 alcohols. In certain embodiments, the carbon-containing compound is a C1-12 aliphatic hydrocarbon compound. In other embodiments, the carbon-containing material is a C6-C12 aromatic compound. In preferred embodiments, the carbon-containing compound is selected from the group consisting of methane, ethane, propane, butane, pentane, ethylene, propylene, butylene, benzene, toluene, xylene, ethylbenzene, naphthalene, acetylene, natural gas, liquified petroleum gas, methanol, ethanol, propanol, butanol, and combinations thereof.

In one more embodiments, the carbon-containing material may comprise a solid material, such as coal, biomass, plastics (e.g., polyethylene or polypropylene), or combinations thereof. Preferably, when solid materials are used as a fuel source, the solids have been ground or comminuted into very fine particulates which have an average particle size (as determined by the particle's largest dimension) of less than 10 microns, less than 5 microns, or less than 1 micron. To facilitate handling, the solid particulates may be disbursed within or a liquid or gas, such as any of the volatile organic compounds described above.

In one or more embodiments, the oxygen-containing material is capable of oxidizing the carbon-containing material upon combustion of the reaction mixture. In certain embodiments, the oxygen-containing material comprises oxygen, either in its elemental form or compounded with other elements. In particular embodiments, the oxygen-containing material is selected from the group consisting of O₂, N₂O, NO, and mixtures thereof. When the oxygen-containing material comprises O₂, the O₂ may be supplied in substantially pure form, (i.e., 99% or greater), as air, or along with other inert materials.

The carbon-containing compound and oxygen-containing material are mixed together to provide a reaction mixture that is combusted as described below. The relative quantities of carbon-containing material and oxygen-containing material present upon combustion affect the composition of the reaction products as evidenced by the following reaction schemes.

The chemistry regarding combustion of carbon-containing materials with an oxygen-containing material is illustrated below in a first reaction scheme using methane and oxygen as the reactants. Equation 1 depicts the stoichiometric reaction for complete combustion of methane with oxygen. In this reaction the molar ratio of O₂/CH₄=2.0, which is equivalent to the atomic ratio O/C=4 (ratio of oxygen atoms to carbon atoms=4).

CH₄+2O₂→CO₂+2H₂O (1)

However, in order to generate syngas components, the reactions need to be fuel rich compared to the stoichiometric reaction. This starves the carbon and hydrogen of the methane for oxygen. For example, for O₂/CH₄=1, there are a number of possible results. From experiments we find essentially no (elemental) carbon is produced. Then, the results for O/C=2.0 are bounded by the two extremes:

CH₄+O₂→CO+H₂+H₂O (2a)

CH₄+O₂→CO₂+2H₂ (2b)

Other O/C ratios have been used and possible reactions are:

O/C=1.8CH₄+0.9O₂→CO+1.2 H₂+0.8H₂O (3a)

CH₄+0.9O₂→0.9CO₂+2H₂+0.1C (3b)

O/C=1.6CH₄+0.8O₂→CO+1.4H₂+0.6H₂O (4a)

CH₄+0.8O₂→0.8CO₂+2H₂+0.2C (4b)

Based upon experimental data for combustion reactions with these three O/C ratios, it was discovered that the reaction that yields the greatest amount of H₂ is when O/C=1.6

O/C=1.6 exp CH₄+0.8O₂→0.7CO+1.48H₂+0.06CO₂+0.52H₂O (5)

Note, missing from Equation 5 is 0.24C and 0.24O. This discrepancy is likely due to measurement difficulties and the lack of the ability to detect H₂O with the equipment used.

The O/C ratio can also be adjusted so that the reaction is geared toward the co-production of syngas components and elemental carbon, primarily in the form of graphene. By further lowering the O/C ratio, water produced during the reaction can be consumed to reduce the CO to form elemental carbon according to the following equations:

CH₄+0.5O₂→CO+2H₂ (6a)

CH₄+0.4O₂→0.8CO+2H₂+0.2C (6b)

Therefore, co-production of syngas components and graphene can be achieved most efficiently at O/C ratios of less than 1.

Another carbon-containing material that can be utilized as a fuel for the syngas-generating reaction is ethanol. The stoichiometric reaction of oxygen and ethanol is

C₂H₅OH+3.5O₂→2CO₂+3H₂O (7)

Equation 7 has O/C=4.0 (including the O in OH). An extremely rich combustion of ethanol assuming no carbon produced would be:

C₂H₅OH+0.5O₂→CO+3H₂ (8)

### Equation 8 has O/C=1.0.

Still another carbon-containing material that can be utilized as a fuel for syngas, and optionally graphene, production is ethylene. Equation 9a illustrates the stoichiometric reaction scheme, and Equations 9b-9d show how reduction in the O/C ratio can lead to production of syngas components, and optionally elemental carbon.

C₂H₄+3O₂→2CO₂+2H₂O (9a)

C₂H₄+O₂→2CO+2H₂ (9b)

C₂H₄+0.9O₂→1.8CO+2H₂+0.2C (9c)

C₂H₄+0.8O₂→1.6CO+2H₂+0.4C (9d)

Yet another carbon-containing material that can be utilized as a fuel for syngas, and optionally graphene, production is toluene. Equation 10a illustrates the stoichiometric reaction scheme, and Equation 10b shows how reduction in the O/C ratio can lead to co-production of syngas components and elemental carbon.

C₇H₈+9O₂→7CO₂+4H₂O (10a)

C₇H₈+3O₂→6CO+4H₂+C (10b)

To generalize the above concepts with regard to any particular hydrocarbon, CₓH_{y}, as a fuel source and O₂ as the oxidant, let z=x(O/C). Then, if z<x, syngas with a molar ratio of H₂/CO=y/2z and x−z moles of C will be created. This relationship is represented by Equation 11.

CₓH_{y}+(z/2)O₂→zCO+(y/2)H₂+(x−z)C (11)

If x+y/2>z>x, no C and syngas with a molar ratio of H₂/CO=(y/2+x−z)/x will be produced, and some H₂ will be lost to water formation. This relationship is represented by Equation 12.

CₓH_{y}+(z/2)O₂→xCO+(y/2+x−z)H₂+(z−x)H₂O (12)

If z>x+y/2, then both H₂O and CO₂ are made to the detriment of syngas production.

Therefore, in order to ensure reaction conditions favorable for the formation of syngas components, rather than CO₂ and water, the ratio of O/C should be less than the stoichiometric ratio for the reactants selected. This produces a fuel rich, or oxygen starved, reaction mixture. In one or more embodiments, the atomic ratio of O/C in the reaction mixture is less than 3.0, 2.5 or less, 2.0 or less, 1.8 or less, 1.7 or less, or 1.6 or less and/or at least 0.5, at least 0.75, at least 1.0, at least 1.2, at least 1.3, or at least 1.4. In one or more embodiments, the atomic ratio of O/C in the reaction mixture is from about 0.5 to about 2.5, from about 1.0 to about 2.0, or from about 1.4 to about 1.8.

The molar ratio of the oxygen-containing material to the carbon-containing material necessary to give the desired atomic ratio of O/C is dependent upon the reactants selected. However, in the case of methane and O₂, the molar ratio of O₂/CH₄ can be less than 2, 1.75 or less, 1.5 or less, 1.25 or less, or 1.0 or less and/or at least 0.25, at least 0.4, least 0.5, at least 0.7, or at least 0.8. In one or more embodiments, the molar ratio of O₂/CH₄ is from about 0.5 to about 1.75, from about 0.7 to about 1.5, or from about 0.8 to about 1.25.

In one or more embodiments, the carbon-containing material from source 12 and the oxygen-containing material from source 14 are mixed together within a premixing vessel 16 to form a combustible mixture prior to being delivered to a combustion chamber 18. Because different fuel sources, or combinations of fuel sources, can be used to generate syngas components, it is important to control the O/C ratio within combustion chamber 18 to favor formation of syngas. Premixing vessel 16 allows the reactants to be mixed to the desired molar ratio prior to being delivered to combustion chamber 18. In one or more embodiments, the pressure of the reactants within premixing vessel 16 is atmospheric or greater than atmospheric. In certain embodiments, the pressure of the reactants within the premixing vessel is at least 1 atm, at least 1.5 atm, at least 2 atm, at least 3 atm, at least 4 atm, or at least 5 atm and/or 10 atm or less, 9 atm or less, 8 atm or less, 7 atm or less, or 6 atm or less.

In one or more embodiments, the combustible mixture passes through a nozzle or injection device 20 en route to combustion chamber 18. The configuration of device 20 may depend upon the type of combustion chamber 18 used in system 10. In one embodiment, combustion chamber 18 is simply a vessel into which the combustible mixture is introduced. This type of combustion chamber, which may be referred to as a “bomb” or “bomb chamber” can range in volume from a few liters to tens or even hundreds of liters depending upon the desired throughput. Combustion is then initiated with a spark-generating device, such as a conventional spark plug (not illustrated). Such combustion chamber is configured for batch-wise production of syngas components. The combustible components are loaded into chamber 18 via a selectively actuatable nozzle 20. Once the chamber 18 is sufficiently charged with reactants, the spark generating device is fired and the reactants ignited. Following combustion, the reaction products, primarily syngas components, are removed from chamber 18 for further processing.

In another embodiment, combustion chamber 18 comprises one or more burners in which the combustible mixture is directed through injection device 20 and into a burner element (not illustrated) located within the combustion chamber 18. Such a combustion chamber is configured for continuous operation and continuous production of syngas components, which are continuously removed from the combustion chamber for further processing. In one particular embodiment, the burner element is a McKenna-type or “flat flame” burner element. In certain embodiments, a flat flame burner comprises a porous metal disc through which the fuel/oxidizer mixture is fed and combusted. This type of burner produces a flat, premixed flame, and may comprise cooling systems to ensure that the desired operational temperature is achieved.

In still another embodiment, combustion chamber 18 comprises an engine in which combustion of the combustible mixture produces mechanical work in addition to the syngas components. In such embodiments, the engine may be, for example, a reciprocating-piston internal combustion engine, a Wankel or rotary engine, or a turbine engine. Thus, the combustion chamber 18 may actually comprise a plurality of individual combustion chambers located within the engine, each of which operates as a batch-wise reactor, but in aggregate produce a continuous output of syngas components. The injection device 20 may comprise one or more electronically-controlled fuel injectors operable to introduce a predetermined quantity of the combustible mixture from premixing vessel 16 into the individual combustion chambers or zones within the engine. One or more ignition devices can then be provided within the engine to ignite the combustible mixture.

Regardless of the configuration of combustion chamber employed, in one or more embodiments, the combustible mixture is combusted within the combustion chamber 18 at a temperature of less than 3000 K, 2500 K or less, or 2000 K or less to produce the syngas components, which generally comprise carbon monoxide and hydrogen. In particular embodiments, the carbon monoxide and hydrogen may be the predominant components. As used herein, the term “predominant” refers to the components present in the greatest quantities as compared to the other components present. This includes components that make up a simple majority (i.e., greater than 50% of the sum total of all components), and components that are simply the most prevalent within a mixture of materials. Other reaction products such as water, carbon dioxide, and elemental carbon can also be produced, generally in minor quantities. However, it is within the scope of the present invention to produce elemental carbon, in the form of graphene particulates.

In one or more embodiments, it is important that the combustion reaction between the carbon-containing material and the oxygen-containing material be a deflagration and not a detonation. The combustion reaction is a net exothermic reaction requiring no energy input beyond that of the ignition source (e.g., spark, pilot flame, etc.). Excess thermal energy generated during the combustion step can be recovered via conventional heat transfer recovery systems (e.g., gas or liquid heat exchangers) and used as needed.

As mentioned previously, in certain embodiments, the reaction products comprise hydrogen and carbon monoxide as the predominant components. However, minor amounts of water, carbon dioxide, and elemental carbon can be present. In certain embodiments, the combusting step is carried out to produce carbon dioxide in an amount that is less than the amount of hydrogen and/or carbon monoxide produced.

In one or more embodiments, the reaction mechanism can be controlled to maximize hydrogen production. In such embodiments, the molar ratio of hydrogen to carbon monoxide produced by the combusting step is at least 1.25, at least 1.5, at least 1.75, or at least 2.0.

In one or more embodiments, it is preferred that the reaction products comprise less than 5%, less than 3%, less than 2%, less than 1%, or less than 0.5% by weight of solid or elemental carbon. As noted previously, in order to maximize production of syngas, the reaction mechanism should favor carbon monoxide production and minimize carbon dioxide production. Therefore, in one or more embodiments, the molar ratio of carbon dioxide to carbon monoxide produced by the combusting step is less than 0.25, less than 0.15, less than 0.1, less than 0.05, or less than 0.01. Likewise, in one or more embodiments, the molar ratio of carbon dioxide to hydrogen produced by the combusting step is less than 0.25, less than 0.15, less than 0.1, less than 0.05, or less than 0.01.

In one or more embodiments, in may be preferred to co-produce significant quantities of elemental carbon, in the form of graphene particulates, along with syngas components. In such embodiments, the reaction products may comprise at least 5%, at least 10%, at least 25%, at least 30%, at least 40%, at least 45%, or at least 50% by weight elemental carbon. The graphene particulates produced may have an average particle size of less than 1 mm, less than 500 m, less than 250 m, or less than 100 m. In such embodiments, the molar ratio of oxygen to carbon within the reaction mixture is controlled to favor formation of at least some elemental carbon. In particular embodiments, this ratio of oxygen to carbon within the reaction mixture is less than 1.0, less than 0.95, less than 0.9, less than 0.85, less than 0.8, less than 0.75, or less than 0.7. In addition, in such embodiments, the molar ratio of carbon monoxide to elemental carbon produced by the combusting step is at least 1, at least 2, at least 3, at least 4, or at least 5.

Following the combustion step, the syngas components are then removed from the combustion chamber 18 and can undergo optional further processing. In one or more embodiments, the reaction products, which may also include some elemental carbon, such as graphene particulates, are removed from reaction chamber 18 and directed to separation equipment 22 in which the syngas components can be separated from each other and/or from the other reaction products. In one or more embodiments, the separation equipment 22 comprises membrane separation equipment that is configured to separate the combustion products into a predominantly hydrogen stream 24 and a predominantly carbon monoxide stream 26. Exemplary membrane separation systems include hollow fiber membrane systems, which may also comprise prefiltering systems to capture coarse and fine particulates, such as graphene particulates that may be included in the reaction products. These streams can be collected and stored in respective vessels 28, 30. The separation process can be conducted to meet any required specifications for the syngas component streams. However, such separation process may need to comprise multiple separation stages, either in series or parallel, in order to meet the called for specs.

In one or more embodiments, pressure swing adsorption (PSA) can be used to separate the syngas components into H₂ and CO. In PSA, selective adsorbents, such as zeolites (molecular sieves) and activated carbon, are used as a trapping material that preferentially adsorbs the target gas species at high pressure. When the pressure is reduced, the gas is released. In addition, the adsorbents can also be selected to remove any graphene particulates present in the reaction products.

Alternatively, various other absorption separation processes can be employed. These other processes utilize water or other solvents that take advantage of the difference in solubility and/or reactivity of CO and H₂. These separation processes may rely upon a water-gas-shift reaction type method (relying upon the catalyzed reactivity of CO and H₂O) in order to separate the syngas components.

In addition, cryogenic processes can also be used to condense or liquefy one or more of the reaction products. Fractionation separation can then be employed, if necessary, on the liquified components.

In embodiments of the present invention that employ a membrane separation system 22, the initial pressurization of the fuel and oxidizer within premixing vessel 16, and subsequent combustion of the fuel and oxidizer under elevated pressure conditions can be coordinated so that membrane separation of the reaction products can occur without the need for boosting the pressure of the reaction products, such as with a compressor system. However, it is within the scope of the present invention to utilize compression of the gaseous components as necessary.

One or more embodiments of the present invention may comprise a digital control system that monitors and controls various aspects of system 10. In one or more embodiments, the control system comprises a controller 32 that is operably connected to one or more valves, mass flow controllers, and/or sensors, for example, within system 10. The embodiment depicted in FIG. 1, controller 32 is operably connected to mass flow controllers 34, 36, which disposed in between sources 12, 14 and premixing vessel 16, and sensor 38, which is disposed downstream of combustion chamber 18.

In this embodiment, sensor 38, which may in actuality comprise more than one detector or even a gas chromatography unit, is configured to sample the reaction products exiting the combustion chamber 18 and determine the relative amounts of the syngas components present therein and transmit that information to controller 32. Controller 32 processes the information received from sensor 38 and can then adjust the operation of mass flow controllers 34, 36 to change the ratio of the oxygen-containing material to carbon-containing material present within the premixing vessel 16. Thus, the digital control system is configured to allow adjustments to be made to the fuel and oxidizer mixture entering the combustion chamber to achieve a desired reaction product specification. For example, if it is desired to increase production of hydrogen within the syngas, controller 32 can adjust the operation of mass flow controllers 34, 36 to increase the fuel richness of the combustible mixture (i.e., lower the oxygen to carbon ratio) within the premixing vessel 16. In any event, in preferred embodiments, the digital control system ensures that the oxygen to carbon ratio for the combustible mixture being introduced into the combustion chamber 18 is less than the stoichiometric oxygen to carbon ratio for the oxygen-containing material and the carbon-containing material.

### EXAMPLES

The following examples illustrate that fuel rich mixtures of methane and oxygen can be combusted in a multi-liter chamber to yield syngas. The combustion is initiated by an electric spark from a spark plug. In addition to syngas, water and a small fraction of carbon dioxide is produced, as is an even smaller amount of elemental carbon. Measured amounts of the product gases were found to be in good agreement with mass balance equations.

It is understood that use of methane as the fuel source and molecular oxygen as the oxidizer in these examples is purely illustrative and should not be taken as limiting upon the scope of the present invention as the principles described herein may be applied to any of the carbon-containing and oxygen-containing materials discussed above. Moreover, the methane used when practicing the present invention need not be pure (i.e., devoid of other hydrocarbons, and could be provided in the form of natural gas, which is typically 80% methane combined with other low hydrocarbons. In addition, liquified petroleum gas, which comprises a mixture of propane, butane, and pentane, can also yield syngas when combusted under fuel rich conditions.

### Experimental Procedure

A 17 L chamber was evacuated to −27.8 in. Hg, gauge (+2.1 in. Hg, absolute) and filled to ˜1 atm absolute (29.9 in. Hg) with the desired O₂/CH₄ ratio by electronic mass flow controllers. Once the chamber is filled, ignition is activated by the pair of electrodes on the top of chamber, and the fuel mixture combusted to yield the syngas. All the systems are controlled by a computer program.

To study the nature of the process a number of measurements and theoretical calculations were made. After successful combustion, over pressure was measured and some pressurized gas was collected in a collection bag through outlet valve for further analysis via gas chromatography. The temperature of the combustion was measured by spectral analysis of the light emitted through a window on the chamber assuming black body Planck radiation. Pressure data was recorded by piezo crystal. Furthermore, a laser beam was projected through the chamber to detect any turbidity due to any carbon particulates formed during the process.

Table 1 gives data for explosions of methane with oxygen.

TABLE 1
Results of explosion of methane with oxygen for four different initial
O/C mixture ratios. All material amounts are moles in the 17-liter chamber at 25° C.

| | Reactants | | Relative over | Calculated products | | | | Measured products | | | |
|---|---|---|---|---|---|---|---|---|---|---|---|
| | (moles/17 L) | | pressure after | (moles/17 L) | | | | (moles/17 L) | | | |
| $\frac{O}{C}$ | CH₄ | O₂ | explosion (atm) | CO | CO₂ | H₂O (Liq) | H₂ | CO | CO₂ | H₂O | H₂ |
| 2.2 | 0.33 | 0.37 | 0.93 | 0.27 | 0.06 | 0.34 | 0.32 | — | — | — | — |
| 2 | 0.35 | 0.35 | 1.03 | 0.33 | 0.02 | 0.37 | 0.37 | 0.25 | 0.034 | | 0.33 |
| 1.8 | 0.37 | 0.33 | 1.23 | 0.32 | 0.05 | 0.24 | 0.49 | 0.26 | 0.029 | | 0.49 |
| 1.6 | 0.39 | 0.31 | 1.39 | 0.35 | 0.04 | 0.19 | 0.59 | 0.27 | 0.024 | | 0.58 |

The theory of the process involves straightforward chemistry, mass balance physics and the ideal gas law. The stoichiometric reaction to totally combust methane with oxygen uses a molar ratio of O₂/CH₄=2.0. It is

CH₄+2O₂→CO₂+2H₂O (1)

The syngas reactions are fuel rich compared to the stoichiometric reaction. This starves the carbon and hydrogen of the methane for oxygen. For example, for O₂/CH₄=1, there are a number of possible results bounded by the two extremes here

CH₄+O₂→CO+H₂+H₂O; nᵢ=2 mole and n_{f}=2 mole, so P_{f}/Pᵢ=1.0 (2a)

CH₄+O₂→CO₂+2H₂; nᵢ=2 mole and n_{f}=3 moles, so P_{f}/Pᵢ=1.5 (2b)

In Eqs. (2) nᵢ is the initial number of moles of total gas loaded into a chamber and n_{f} is the final number of gaseous moles produced by the reaction. From the number of gaseous moles and the ideal gas law, one can infer how the initial and final pressures in the chamber compare. These pressures can be measured, their ratio calculated, and from that pressure ratio the molar ratios of H₂/CH₄, CO/CH₄ and H₂/CO can be calculated.

CH₄+0.9O₂→CO+1.2H₂+0.8H₂O; nᵢ=1.9 mole and n_{f}=2.2 mole, so P_{f}/Pᵢ=1.16 (3a)

CH₄+0.9O₂→0.9CO₂+2H₂+0.1C; nᵢ=1.9 mole and n_{f}=2.9 mole, so P_{f}/Pᵢ=1.53 (3b)

CH₄+0.8O₂→CO+1.4H₂+0.6H₂O; nᵢ=1.8 mole and n_{f}=2.4 mole, so P_{f}/Pᵢ=1.33 (4a)

CH₄+0.8O₂→0.8CO₂+2H₂+0.2C; nᵢ=1.8 mole and n_{f}=2.8 moles, so P_{f}/Pᵢ=1.56 (4b)

Linear interpolations lead to the following equations the molar ratios H₂/CH₄ and CO/CH₄ as functions of the pressure ratio:

O₂/CH₄=1: H₂/CH₄=2P_{f}/Pᵢ−1 (5a)

CO/CH₄=−2P_{f}/Pᵢ+3 (5b)

O₂/CH₄=0.9: H₂/CH₄=2.17P_{f}/Pᵢ−1.312 (6a)

CO/CH₄=−2.72P_{f}/Pᵢ+4.16 (6b)

O₂/CH₄=0.8: H₂/CH₄=2.61P_{f}/Pᵢ−2.07 (7a)

CO/CH₄=−4.35P_{f}/Pᵢ+6.79 (7b)

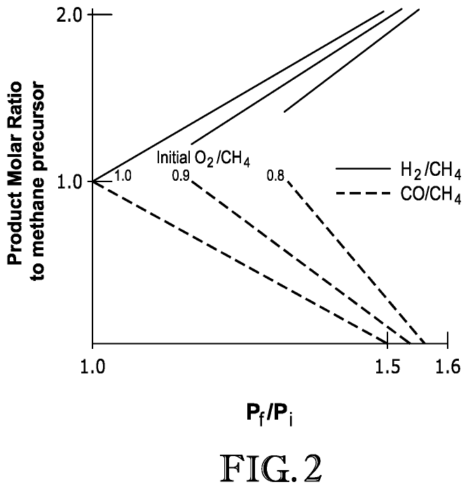

The results of these equations are plotted in FIG. 2. With these results, it is a simple matter to measure the initial and final pressures in the chamber and determine the expected, theoretical product molar ratios H₂/CH₄ and CO/CH₄. Results of these calculations are given in Table 1 and are seen to agree well with measured values.

### Cost Analysis

According to the US Energy Information Administration the industrial price of natural gas ranged from $3.66 to $2.72 per 1000 cubic feet from January to June 2020. Assuming an average price of $3.00 and combined with the above-demonstrated range of production molar ratios of H₂/CH₄=1.06 to 1.51, the above process can yield H₂ at a price of $0.86 to $1.23 per kilogram. These values are far below current processes of 1) Gray hydrogen produced by steam reforming of natural gas, $1.60, 2) Blue hydrogen produced by steam reforming of natural gas with capture and storage of CO₂, $2.10, and 3) Green hydrogen produced by electrolysis of water using renewable energy, $6.00.

Given the fact that the U.S.A. has a nationwide natural gas distribution infrastructure, methods according to embodiments of the present invention are advantageous because they will allow production of hydrogen at the point of use. There will be no need to develop a separate hydrogen distribution infrastructure. Moreover, the capital cost of a steam reforming plant is considerable and not conducive to small to medium size facilities. Furthermore, conventional processes for syngas generation make intensive use of energy. They operate at pressures between as high as 600 psi and temperatures in the range of 900° C. Avoiding these extreme conditions is highly advantageous from a cost perspective.

1. A method of synthesizing syngas components comprising:
providing within a combustion vessel a mixture comprising a combustible carbon-containing material and an oxygen-containing material; and
combusting the mixture within the vessel at a temperature of less than 3000 K and generating carbon monoxide and hydrogen as combustion products.

2. The method of claim 1, wherein the oxygen to carbon ratio within the mixture is less than 2.0.

3. The method of claim 2, wherein the oxygen to carbon ratio within the mixture is less than 1.0.

4. The method of claim 1, wherein the combustion products produced in the combusting step comprise less than 5% by weight of elemental carbon.

5. The method of claim 1, wherein the carbon-containing material comprises at least one saturated or unsaturated C₁-C₁₂ hydrocarbon compound and/or at least one C₁-C₁₂ alcohol.

6. The method of claim 5, wherein the carbon-containing material is selected from the group consisting of methane, ethane, propane, butane, pentane, ethylene, propylene, butylene, benzene, toluene, xylene, ethylbenzene, naphthalene, acetylene, natural gas, liquified petroleum gas, methanol, ethanol, propanol, butanol, and combinations thereof.

7. The method of claim 1, wherein the oxygen-containing material comprises elemental oxygen.

8. The method of claim 1, wherein the providing step comprises:
(a) premixing the carbon-containing material and the oxygen-containing material within a mixing vessel to form the mixture; and
(b) introducing the mixture into the combustion vessel.

9. The method of claim 1, wherein the combustion vessel comprises a combustion chamber having a spark-generating device installed therein capable of initiating combustion of the mixture.

10. The method of claim 1, wherein the combustion vessel comprises a combustion chamber having a burner element installed therein that is capable of continuously combusting the mixture.

11. The method of claim 1, wherein the molar ratio of hydrogen to carbon monoxide produced by the combusting step is at least 1.25.

12. The method of claim 1, wherein the combusting step also produces carbon dioxide in an amount less than that of either the hydrogen or carbon monoxide.

13. The method of claim 12, wherein the molar ratio of carbon dioxide to carbon monoxide produced by the combusting step is less than 0.25.

14. The method of claim 12, wherein the molar ratio of carbon dioxide to hydrogen produced by the combusting step is less than 0.25.

15. The method of claim 1, wherein carbon monoxide and hydrogen are generated as the predominant combustion products.

16. The method of claim 1, wherein the combustion products produced in the combusting step comprise at least 10% by weight of elemental carbon in the form of graphene.

17. The method of claim 1, wherein the molar ratio of carbon monoxide to elemental carbon produced by the combusting step is at least 1.

18. A method of synthesizing syngas components comprising:
premixing a carbon-containing material with an oxygen-containing material to form a combustible mixture, wherein the carbon-containing material comprises at least one of methane, ethane, propane, butane, pentane, ethylene, propylene, butylene, benzene, toluene, xylene, ethylbenzene, naphthalene, acetylene, methanol, ethanol, propanol, and butanol;
introducing the combustible mixture into a combustion chamber; and
combusting the combustible mixture within the combustion chamber at a temperature of 2000 K or less and generating carbon monoxide and hydrogen as combustion products.

19. Apparatus for synthesizing syngas components comprising:
at least one source of a carbon-containing material;
at least one source of an oxygen-containing material;
a mixing vessel operably coupled with the at least one source of a carbon-containing material and the at least one source of an oxygen-containing material, the mixing vessel being configured to receive and mix the carbon-containing material and the oxygen-containing material from each respective source and to form a combustible mixture;
a combustion vessel operably coupled with the mixing vessel and configured to receive the combustible mixture from the mixing vessel and combust the combustible mixture within the combustion vessel to generate carbon monoxide and hydrogen as combustion products, wherein the combustion vessel is configured to combust the combustible mixture at a temperature of less than 3000 K; and
a digital control system that is configured to control the ratio of oxygen-containing material to carbon-containing material within the mixing vessel to provide an oxygen to carbon ratio that is less than the stoichiometric oxygen to carbon ratio for the oxygen-containing material and the carbon-containing material.

20. The apparatus of claim 19, wherein the combustion vessel comprises a combustion chamber having a spark-generating device installed therein capable of initiating combustion of the mixture.

21. The apparatus of claim 19, wherein the combustion vessel comprises a combustion chamber having a burner element installed therein that is capable of continuously combusting the mixture.

22. The apparatus of claim 21, wherein the burner element is a flat flame burner.

23. The apparatus of claim 19, wherein the apparatus further comprises membrane separation equipment operable to separate the combustion products into a predominantly hydrogen stream and a predominantly carbon monoxide stream.

24. A method of synthesizing syngas components comprising:
introducing into a premixing vessel at least one source of a carbon-containing material and at least one source of an oxygen-containing material to form a combustible mixture, wherein the ratio of the oxygen-containing material to the carbon-containing material within the premixing vessel is controlled to provide an oxygen to carbon ratio that is less than the stoichiometric oxygen to carbon ratio for the oxygen-containing material and the carbon-containing material;
feeding at least a portion of the combustible mixture to a combustion vessel; and
combusting the combustible mixture within the combustion vessel at a temperature of less than 3000 K to generate carbon monoxide and hydrogen as combustion products.

25. The method of claim 24, wherein the pressure within the premixing vessel is at least 2 atm.

26. The method of claim 25, wherein the method further comprises the step of feeding the combustion products to membrane separation equipment and separating the combustion products into a predominantly hydrogen stream and a predominantly carbon monoxide stream.

27. The method of claim 24, wherein the combustion products produced in the combusting step comprise elemental carbon in the form of graphene particulates.

28. The method of claim 27, wherein the combustion products are processed to separate the carbon monoxide and hydrogen from the graphene particulates.

29. The method of claim 28, wherein the separation processing comprises pressure swing adsorption processing of the combustion products, membrane separation processing, condensation processing, or fractionation processing.
